(19) United States
(12) Patent Application Publication
(10) Pub. No.: US 2016/0205248 A1
(43) Pub. Date: Jul. 14, 2016

(54) SYSTEM, METHOD AND APPARATUS FOR MOBILE CALL CENTERS

(71) Applicant: Spokeadot, LLC, Iowa City, IA (US)

(72) Inventors: GREGORY P. PROBST, Iowa City, IA (US); WILLIAM D. BELL, Abilene, TX (US)

(21) Appl. No.: 14/992,471

(22) Filed: Jan. 11, 2016

Related U.S. Application Data
(60) Provisional application No. 62/101,625, filed on Jan. 9, 2015.

(51) Int. Cl. H04M 3/51

(52) U.S. Cl. CPC H04M 3/5158; H04M 3/5183

(57) ABSTRACT

The present invention relates to a system, method, and apparatus for a Mobile Call Center System (MCC) that integrates telemarketing services for a business owner. The MCC may allow business owners to generate a call list based on defined metrics. Furthermore, the present invention's MCC Platform provides a variety of controls that allow Call Agents, who may be employed or contracted, to answer calls based upon their availability, schedule, time of day, and/or any combination of parameters, rules, and roles, and to incorporate the use of the mobile device. The method may include generating a call list base on a set of user defined metrics and contacting a business owners potential customers.

### CROSS-REFERENCED APPLICATIONS

This application claims priority under 35 U.S.C. §116 to provisional application Ser. No. 62/101,625, which was filed on Jan. 9, 2015, the entire contents of which is herein incorporated by reference.

### FIELD OF THE INVENTION

The present invention relates generally to a system, method, and apparatus for a Mobile Call Center System (MCC) that integrates telemarketing services for a business owner.

### BACKGROUND OF THE INVENTION

Today, when a business wishes to obtain new customers they often resort to telemarketing and other forms of direct marketing campaigns. In some cases, the business owner, and/or business operator, who would be making such calls or actively engaged in the telemarketing activity is also significantly involved in the day to day activities of their business, such as, but not limited to: making a delivery, snow removal, maintenance, etc. Often, there is idle time between jobs that can be used to call customers, and today one method is to have the numbers written on a piece of paper or working from a list and manually dialing the customer. This has several drawbacks including a safety issue where the owner is trying to manually read a number and dial it while operating a motor vehicle, or other machinery. Another aspect, is the ability to take notes regarding the call results, such as, but not limited to, “successfully contacted”, “busy signal”, “interested”, “follow-up next week”, etc.

The second drawback is the time wasted on calls that do not answer and/or are busy. Manual effort does not allow for efficiencies in contacting the potential customer. Also, if the owner makes a call and suddenly becomes unavailable during the call process, the call is abandoned because the relationship is one to one, in other-words, there is a one outbound caller to the one potential customer receiving the call.

Another drawback to manually calling each customer is that is does not provide the caller an opportunity to narrow potential customers to call based on level of interest.

What is needed, is a system, method, and apparatus that solves these, and other problems efficiently, and cost effectively.

### OBJECTS AND FEATURES OF THE INVENTION

It is an object of the present invention to provide a system, method, and apparatus for a Mobile Call Center System.

It is an object of the present invention to provide a system, method, and apparatus for a Mobile Call Center System that is efficient, and cost effective.

It is an object of the present invention to provide a system, method, and apparatus for a Mobile Call Center System that may use a demand based pricing model based on Call Agent supply vs. demand on the system.

It is an object of the present invention to provide a Mobile Call Center System that can be used for telemarketing.

It is an object of the present invention to provide a Mobile Call Center System for uses other than telemarketing, including, but not limited to: appointment/service scheduling, reminders or follow-ups, service/appointment quality polling, etc.

It is a feature and object of the present invention to provide for call routing to the mobile phone of a Call Agent of the Mobile Call Center System.

It is a feature and object of the present invention to build a Platform using public networks.

It is a feature and object of the present invention to build a Platform using private networks.

It is a feature and object of the present invention to build a Platform using a hybrid of public and private networks.

It is a feature and object of the present invention for the IT hardware, and software, that comprises the functionality of the Mobile Call Center Platform to be co-located.

It is a feature and object of the present invention for the IT hardware, and software, that comprises the functionality of the Mobile Call Center Platform to be geographically dispersed across multiple vendors at different locations in the world.

It is a feature and object of the present invention for the IT hardware, and software, that comprises the functionality of the Mobile Call Center Platform to be co-located and/or geographically dispersed across multiple vendors at different locations in the world.

It is a feature and object of the present invention to incorporate web servers.

It is a feature and object of the present invention to incorporate file servers.

It is a feature and object of the present invention to incorporate databases.

It is a feature and object of the present invention to incorporate virtualization technologies.

It is a feature and object of the present invention to incorporate REST API, and other inter-process communication Platforms.

It is a feature and object of the present invention to incorporate security protection measures in the system.

It is a feature and object of the present invention to incorporate reliability measures in the system.

It is a feature and object of the present invention to provide scalability in the system.

It is a feature and object of the present invention to provide redundancy capabilities in the system.

It is a feature and object of the present invention to provide data caching.

It is a feature and object of the present invention to audio and video playback and recording capabilities in the system.

It is a feature and object of the present invention to use contact lists.

It is a feature and object of the present invention to use contact lists that have been uploaded by a business operator.

It is a feature and object of the present invention to use contact lists that have been provided by third-parties.

It is a feature and object of the present invention to use third party contact lists that have been acquired via import as one, or more, batch files.

It is a feature and object of the present invention to use third party contact lists that have been acquired using application programming interfaces.

It is a feature and object of the present invention to use third party contact lists that have been acquired by user interface.

It is a feature and object of the present invention to provide demographic attributes to define contact lists.

It is a feature and object of the present invention to provide filters to define contact lists.

It is a feature and object of the present invention to provide rules to govern contact list management.

It is a feature and object of the present invention to provide Call Agents the capability to initiate processing rules of a contact list.

It is a feature and object of the present invention to provide Call Agents the capability to override processing rules of a contact list.

It is a feature and object of the present invention to provide Call Agents the capability to override processing rules of a contact list according to availability of the Call Agent.

It is a feature and object of the present invention to provide Call Agents the capability to override processing rules of a contact list according to “Do Not Call List” restrictions.

It is a feature and object of the present invention to provide Call Agents the capability to override processing rules of a contact list according to time of day and time zone considerations for potential customers on the contact list, and the Call Agents.

It is a feature and object of the present invention to provide Call Agents the capability to override processing rules of a contact list according to business operation hours.

It is a feature and object of the present invention to provide Call Agents the capability to override processing rules of a contact list according to skill level, roles, certifications, and training of a Call Agent.

It is a feature and object of the present invention to provide a software application for a Call Agent to interact with the Mobile Call Center System.

It is a feature and object of the present invention to provide pre-recorded audio messages, with or without configurable scripting, for a customer when the answer their phone.

It is a feature and object of the present invention to provide voice recognition capabilities as means for a customer to interact with the platform.

It is a feature and object of the present invention to provide imaging capabilities as means for a customer to interact with the platform.

It is a feature and object of the present invention to use location capabilities as means for a customer to interact with the platform.

It is a feature and object of the present invention to provide touch pad capabilities as a means for a customer to interact with the platform.

It is a feature and object of the present invention to provide keyboard input capabilities as a means for a customer to interact with the platform.

It is a feature and object of the present invention to provide biometric capabilities as a means for a customer to interact with the platform.

It is a feature and object of the present invention to provide imaging capabilities as a means for a customer to interact with the platform.

It is a feature and object of the present invention to use location capabilities as a means for a customer to interact with the platform.

It is a feature and object of the present invention to provide touch pad capabilities as a means for a customer to interact with the platform.

It is a feature and object of the present invention to provide touch screen capabilities as a means for a customer to interact with the platform.

It is a feature and object of the present invention to provide keyboard input capabilities as a means for a customer to interact with the platform.

It is a feature and object of the present invention to provide voice recognition capabilities as a means for a Call Agent to interact with the platform.

It is a feature and object of the present invention to provide imaging capabilities as a means for a Call Agent to interact with the platform.

It is a feature and object of the present invention to use location capabilities as a means for a customer to interact with the platform.

It is a feature and object of the present invention to provide touch pad capabilities as a means for a Call Agent to interact with the platform.

It is a feature and object of the present invention to provide touch screen capabilities as a means for a Call Agent to interact with the platform.

It is a feature and object of the present invention to provide keyboard input capabilities as a means for a Call Agent to interact with the platform.

It is a feature and object of the present invention to provide pre-recorded video messages, with or without configurable scripting, for a customer when the answer their phone with video call capabilities.

It is an object of the present invention to build a list driven Mobile Call Center System to overcome limitations in the marketplace.

### BRIEF DESCRIPTION OF THE FIGURES

FIG. 1 is a flow chart of processes used in the present invention.

FIG. 2 is a flow chart of a sub-process used in the present invention.

FIG. 3 is a flow chart of a sub-process used in the present invention.

FIG. 4 is a flow chart of functional components used in the present invention.

### SUMMARY OF THE INVENTION

Many of today's small businesses are owned, and/or operated, by individuals who perform their jobs on a day-to-day basis with little time to proactively make sales and marketing calls to potential customers and clients. Examples of these businesses include, but are not limited to: massage therapists, lawn care companies, etc. When the individuals who own, and/or operate, these businesses do have a few minutes in between jobs or activities, it's a time consuming and inefficient process for them to find a list, call the person on that list, wait for an answer, and then repeat the process until a potential customer answers. The process is particularly complicated, or may be restricted legally, when one is engaged in other simultaneous activities such as driving, navigating, etc.

A new and alternative approach is for these business operators to create and upload a list of potential and existing customers to a Platform that manages the call efforts on their behalf. In addition, the Mobile Call Center System (MCC) (“Mobile Call Center”, or “Mobile Call Center System”, or “MCC”, hereinafter, may be also be used interchangeably with the term “the present invention”), may automatically provide lists or sources of possible customers by integrating with third-party data companies by any number of methods (batch file imports, application programming interface, user-interface) who can provide potential customers based on any number of Platform (the use of the word “Platform” hereinafter, may be also interchangeably with the term “the present invention”), or Call Agent defined customer demographic attributes and filters.

When a Call Agent is qualified, and available, to handle calls with customers, he or she simply informs the Platform via an application residing on a device, such as, but not limited to, their smart phone, tablet, PC, e.g. iPhone, iPad, Android, Mac, PC, etc, and the Platform begins placing calls to the end-customers on their behalf.

If a customer who is called by the MCC Platform answers their phone, then either 1) the Platform can play a pre-recorded audio message with or without configurable scripting followed-by an optional connection to the available Call Agent, or 2) simply connect them to the Call Agent. If more than one Call Agent is available to respond to a customer called by the Platform, the Platform will continue to proceed through the list until the there are no more available operators are available, or an end-of-list processing rule is encountered.

In the event the MCC Platform is unable to contact any of the customers as it progresses through the list of customers or potential customers in the batch, and the Platform will cease processing, including, but not limited according to one of the following conditions: 1) upon reaching end of list of available customers to call, 2) upon reaching a list state where all numbers have been answered or satisfactorily processed, 3) a time-frame is encountered where calling customers is prohibited as defined by the Call Agent, 4) there are no longer any available Call Agents to answer calls, or 5) a Call Agent places the Platform's processing of their calls in a state of hibernation or a wait state.

Similarly, the MCC System can initiate or override processing rules of the Call List Batch as well. They can also build rules, roles and restrictions for the MCC application including, but not limited to: 1) availability of agents, 2) “Do Not Call List” restrictions, 3) time of day and time zone considerations for both potential customers on the list, and the Call Agents, 4) business operation hours, 5) skill levels of each particular Call Agents, 6) roles for each particular Call Agent, 7) a Call Agent's certifications, and 8) a Call Agent's training.

The present invention's Mobile Call Center Platform integrates telemarketing services with a variety of controls that allows Call Agents to use their mobile device to answer calls based upon things such as, but not limited to: 1) their availability, 2) scheduling, 3) time of day, and/or 4) any combination of the aforementioned, and other parameters, rules, and roles.

The MCC Platform can include a combination of disparate, and inclusive systems, that are interconnected via public and private networks. Pieces, parts, and functionality of the MCC Platform may be co-located and/or geographically dispersed across multiple vendors at different locations throughout the world.

The Platform provides capabilities, such as, but not limited to, imaging, touch pad, touch screen, location, voice recognition, etc, as means for Business Owners, Business Operators, Customers, and Call agents to interact with the system.

The Platform includes, but is not limited to traditional computing technologies such as web servers, file servers, databases, VoIP call processing, REST APIs and other inter-process communication methods, virtualization, security protection measures, reliability, redundancy, scalability, caching, audio and video payback and recording capabilities, etc.

The present invention is described primarily for use as a telemarketing application, but one skilled in the art will instantly recognize the Platform is useful for other purposes, such as, but not limited to: appointment/service scheduling, reminders or follow-ups, service/appointment quality polling, etc.

Furthermore, one skilled in the art will instantly recognize the Platform can be used in conjunction with a video call, and video messages could be played in the place of audio only messages.

### DETAILED DESCRIPTION OF THE PRESENT INVENTION

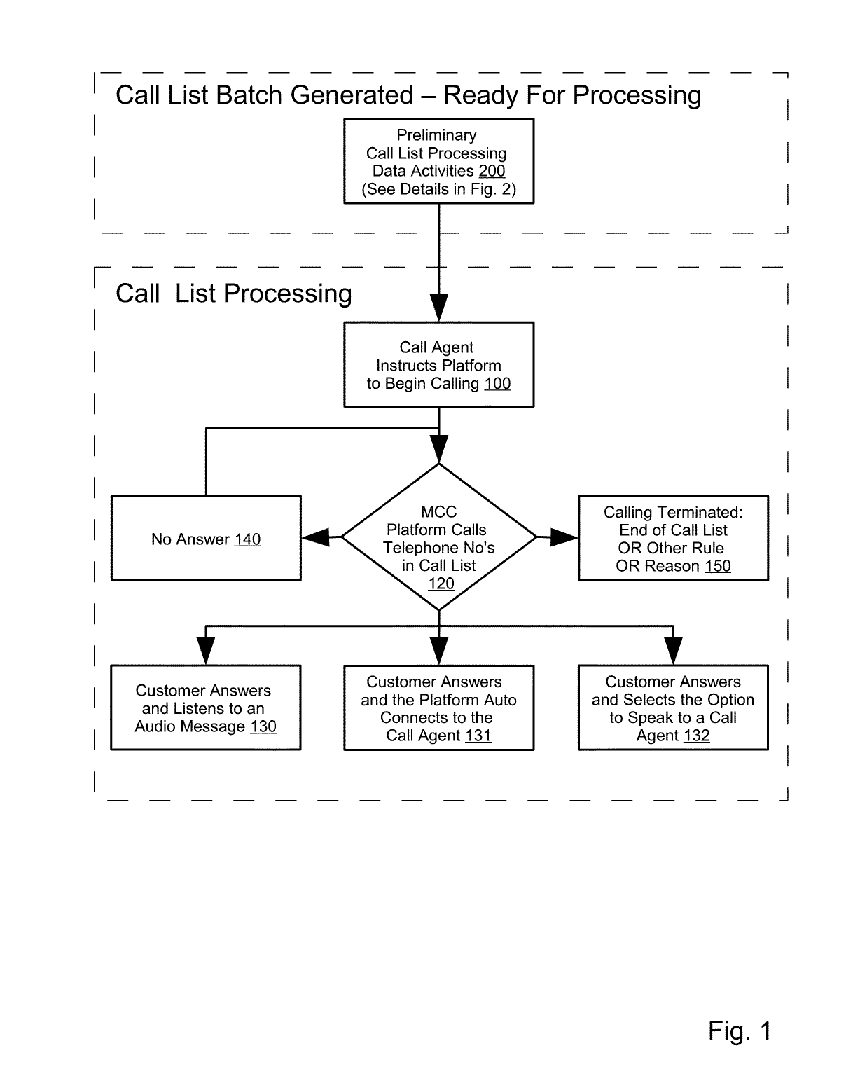

FIG. 1 is an illustration of the high level processes used in the present invention to generate and process Call Lists.

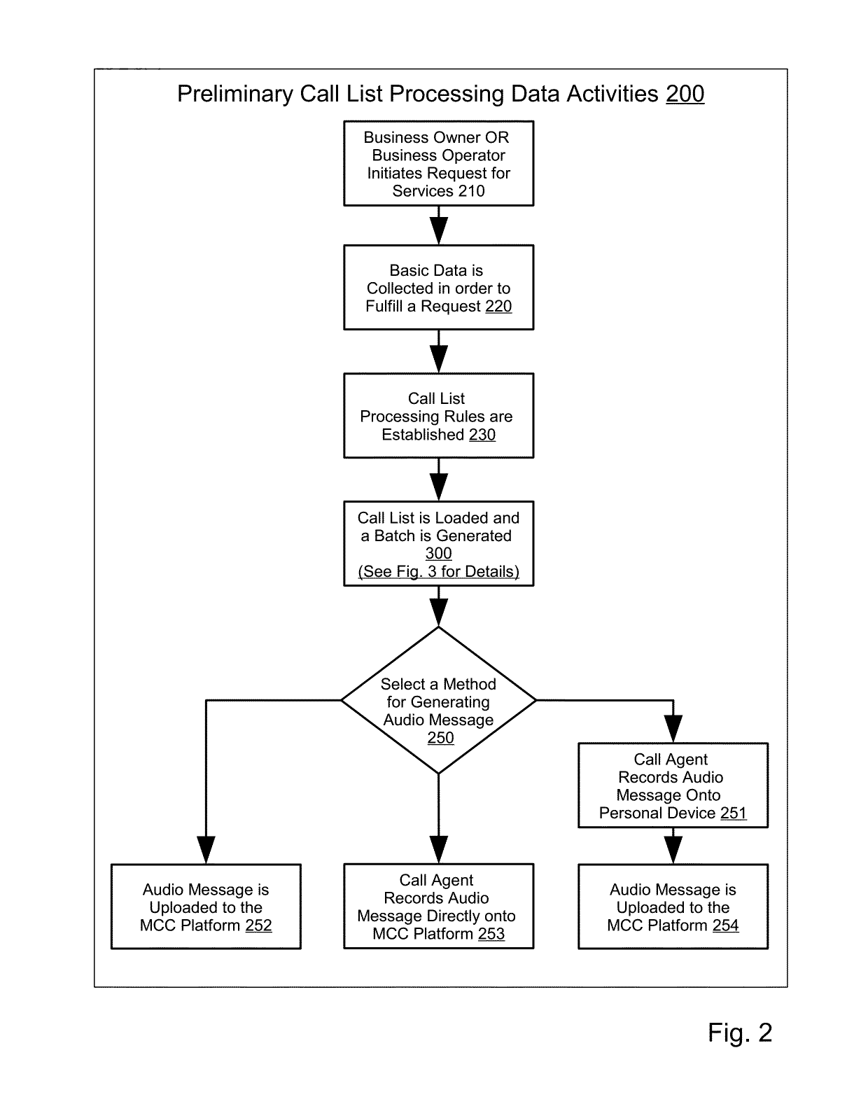

Preliminary Call List Processing Data Activities 200 illustrates there is a series of preliminary steps that are required prior to the processing of a Call List Batch. These preliminary Call List Batch Generation steps are further illustrated in FIG. 2.

Call List Batch Processing begins after a Call List Batch has been prepared and is resident in the present invention's information technology hardware and software infrastructure, which includes, but is not limited to, a combination of disparate, and inclusive systems, that are interconnected via public and private networks. Pieces, parts, and functionality of the MCC Platform may be co-located and/or geographically dispersed across multiple vendors at different locations throughout the world. These pieces, parts, and funcationalities, include, but are not limited to, traditional computing technologies such as web servers, file servers, databases, VoIP call processing, REST APIs and other inter-process communication methods, virtualization, security protection measures, reliability, redundancy, scalability, caching, audio and video payback and recording capabilities, etc.

A Call Agent, who has a business relationship with the present invention's business entity, logs on to the MCC (step not shown). The Call Agent can log on, and interact, with the present invention via an application residing on a device, such as, but not limited to, a smart phone, tablet, laptop, desktop, etc, running on virtually any O/S. Once a Call Agent is logged on, they may choose to preform a variety of pre-Call List Batch Processing tasks, such as, but not limited to: checking internal messages generated by the system; updating their account profile information; changing their password; opting in to complete at least a portion of at least one Call List Batch Processing job; checking their personal metrics vs. other individuals, or groups of, Call Agents; checking on, or updating, certifications that may be required by the present invention's business entity, or a business owner and/or operator that is using the MCC Platform for telemarketing, or other, purposes; taking on-line training delivered by the MCC that may be necessary to be considered to be engaged in at least one portion of at least one specific Call List Batch; completing suggestions for improvements to the system; etc. (none of the aforementioned steps are shown).

In addition to the aforementioned pre-Call List Batch Processing tasks, the Call Agent can enter into a part of the MCC system to perform other tasks prior to instructing the Platform to begin calling, these tasks may include, but are not limited to: establishing their availability during the day, and/or the next week, and/or the next month; confirming their location; confirming their time zone(s) during their times of availability if they are traveling; etc. (none of the aforementioned steps are shown).

In addition to the voice scripts available for use in the Call Batch Processing, there may be requirements for some business specific call-flow processes. For example, the Call Agent may wish the present invention's Mobile Call Center Platform to acknowledge that a real human has answered the phone versus an answering machine or voice mail by asking the customer to depress a key(s) or press a particular button(s) causing a DTMF tone(s) to be generated on their phone or device back to the present invention's Mobile Call Center Platform prior to playing the remainder of the message. Dual-tone multi-frequency signaling (DTMF) is an in-band telecommunication signaling system using the voice-frequency band over telephone lines between telephone equipment and other communications devices and switching centers. Even though mobile phone networks use digital signals instead of DTMF for direct dialing, DTMF is still used over mobile phones to navigate automated systems such as phone menus, and for secondary dialing, such as using a calling card. DTMF is standardized by ITU-T Recommendation Q.23. It is also known in the UK as MF4. DTMF is the industry standard for landline and mobile service. Other multi-frequency systems are used for internal signaling within the telephone network.

In another example, the Call Agent may simply want to play the message regardless of human detection. Alternatively, the Call Agent may wish a different script to be played upon human detection, answering machine detection or other answer attributes. Regardless, the present invention's Mobile Call Center Platform is configurable to meet the Call Agent's customer treatment by providing an application framework that includes, but is not limited to: 1) actions based upon method or attributes of answer including human vs. automated answering, length of time to answer, no answer, busy, errors; 2) one or more collections of information from the customer via voice and/or key press along during the entire present invention's Mobile Call Center Platform interaction, e.g. a series of survey questions or traversing a menu, verification of information, requests for transfer, requests for operator, hang-up and/or disconnections, etc; 3) different script(s) depending on the present invention's Mobile Call Center Platform's detection of or pre-defined customer attributes including, but not limited to gender, age, dialect, etc; and 4) different scripts and call processing actions interdependent on prior actions and inputs, e.g. “press one to transfer” results in a transfer; etc. (none of the aforementioned steps are shown).

Once the present invention's Mobile Call Center Platform has the required scripts, call flows defined, the specific Call List Batch Processing for a marketing campaign can begin by at least one Call Agent for a particular job at any given time, who have access to a telephone and/or smart device that has VoIP, or other audio and video capabilities.

The next step in the process illustrated in FIG. 1 is the Call Agent Instructs Platform to Begin Calling 100. As previously described, the Call Agent interacts with the present invention via an application residing on a device, such as, but not limited to, a smart phone, tablet, laptop, desktop, etc, running on virtually any O/S.

The next step in the process illustrated in FIG. 1 is the MCC Platform Calls Telephone No's in Call List 120.

The present invention's Mobile Call Center Platform performs outbound calls. One possible outcome of placing an outbound call is there is No Answer 140, which may include, but is not limited to, “no answer”, a “busy signal, a “bad number”, etc. If so, then the step MCC Platform Calls Telephone No's in Call List 120 is repeated until a customer answers, or there are no longer any Call Agents available, or the window for availability is closing for an existing available Call Agent.

There could be other rules imposed on the present invention's Mobile Call Center Platform that would cause it to cease call processing potential clients even though a Call Agent is currently available. For example, the MCC Platform could detect that a currently available Call Agent is in close proximity to their next scheduled appointment, or at some other location and will soon not be available to take a customer call. Other factors may include the Call Agent's climate and traffic conditions, if they are moving, and current environmental aspects including background noise that will keep the Call Agent and customer from having a a good conversation, and other inputs.

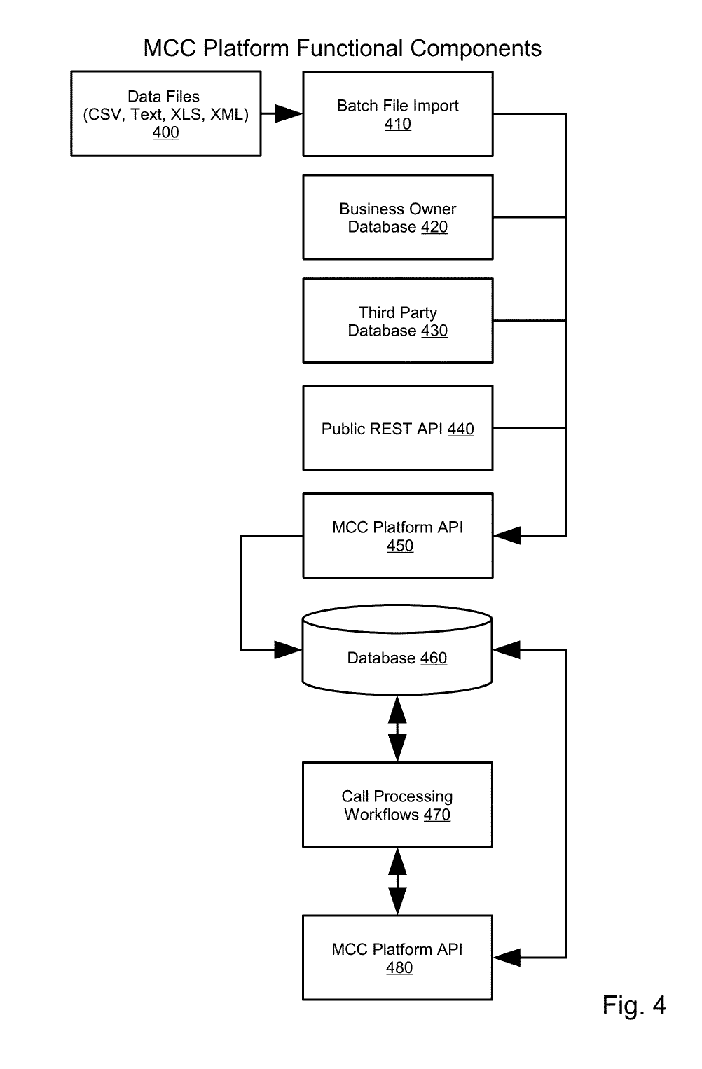

Annotations regarding either “no answer”, or “busy signal”, or “bad number”, etc. are made in the present invention's Database 450 as shown in FIG. 4, may include, but are not limited to: date stamp, time stamp, etc., are made in Database 450.

When a customer answers the MCC Platform's call, there are a variety of actions that can be taken depending on the particular flow as noted previously.

In one instance, the end result of an automated outbound call by the present invention is the step the Customer Answers and Listens to Audio Message 130.

In another instance, the end result of an automated outbound call by the present invention is the step Customer Answers and the Platform Auto Connects to the Call Agent 131.

In yet another instance, the end results of an automated outbound call by the present invention is the Customer Answers and Selects the Option to Speak to a Call Agent 132.

The Call Agent's application provides him, or her, the ability to take notes during a call with a customer in either the Customer Answers and the Platform Auto Connects to the Call Agent 131 process, or the Customer Answers and Selects the Option to Speak to a Call Agent 132 process.

The present invention's Mobile Call Center Platform may have rules indicating the type of representative connected in terms such as, but not limited to: priority, skills (skill-based routing), certifications, training, current availability, future availability, etc, in the event more than one Call Agent is available.

There could be other rules imposed on the present invention's Mobile Call Center Platform that would cause it to cease call processing potential clients even though a Call Agent is currently available. For example, the MCC application could detect that a currently available Call Agent is in close proximity to their next scheduled appointment or at some other location and is or shortly will not be available to take a customer call. Other factors may include climate and traffic conditions, movement detection, and current environmental aspects including noise, i.e. cannot have a good conversation if the application detects excessive background noise and other inputs.

The present invention's Mobile Call Center Platform will continue placing outbound call attempts to potential customers on the Call Batch List until one answers, or there are no longer any Call Agents available, or the window for availability is soon closing for an existing available Call Agent.

The Platform provides capabilities, such as, but not limited to, imaging, touch pad, touch screen, location, voice recognition, etc, as means for Business Owners, Business Operators, Customers, and Call agents to interact with the system.

It will be obvious to one skilled in the art, there are many other outcomes related to automatic outbound calls that can be programmed into the present invention's flexible MCC Platform Application.

It will be obvious to one skilled in the art, there in the place of audio only messages, the present invention can use video messages as well.

FIG. 2 is an illustration of the high level processes used in the present invention that describe Preliminary Call List Processing Data Activities 200 for a job batch.

In the sub-process, first, the Business Owner OR Business Operator Initiates Request for Services 210. They can access the present invention's Mobile Call Center Platform a variety of ways, including, but not limited to: via an application residing on a device, such as, but not limited to, a smart phone, tablet, laptop, desktop, etc, running on virtually any O/S. They may access the present invention as a guest user, or as a registered user of the system.

Once the Business Owner or Business Operator is connected to the present invention's platform, they are prompted by the system so that Basic Data is Collected in order to Fulfill a Request 220. This basic data can include, but is not limited to: business name, physical address, mailing address, billing information, contact name, telephone numbers, source of call list, uploading a call list, length of campaign, type of campaign, time zone restrictions, training materials, time-of-day restrictions, day-of-week restrictions, holiday restrictions, reporting requirements, do not call indicator, IP address or domain name for methods of contact including, but not limited to: VoIP, SIP or other audio/video methods that may be proprietary in nature, such as, but not limited to: Skype, iMessage, and SMS, etc.

Using the information gathered in the step Basic Data is Collected in order to Fulfill a Request 220, the present invention uses information gathered from available Call Agents, and the Call List Processing Rules are Established 230. As an example, the Call Agent may have entered into the MCC system restrictions such as, but not limited to: establishing their availability during the day, and/or the next week, and/or the next month; confirming their location; confirming their time zone(s) during their times of availability if they are traveling; etc. (none of the aforementioned steps are shown). All of the available Business Owner or Business Representative data is combined with data from at least one Call Agent, and the Call List Processing Rules are Established 230 for a particular Call List Batch.

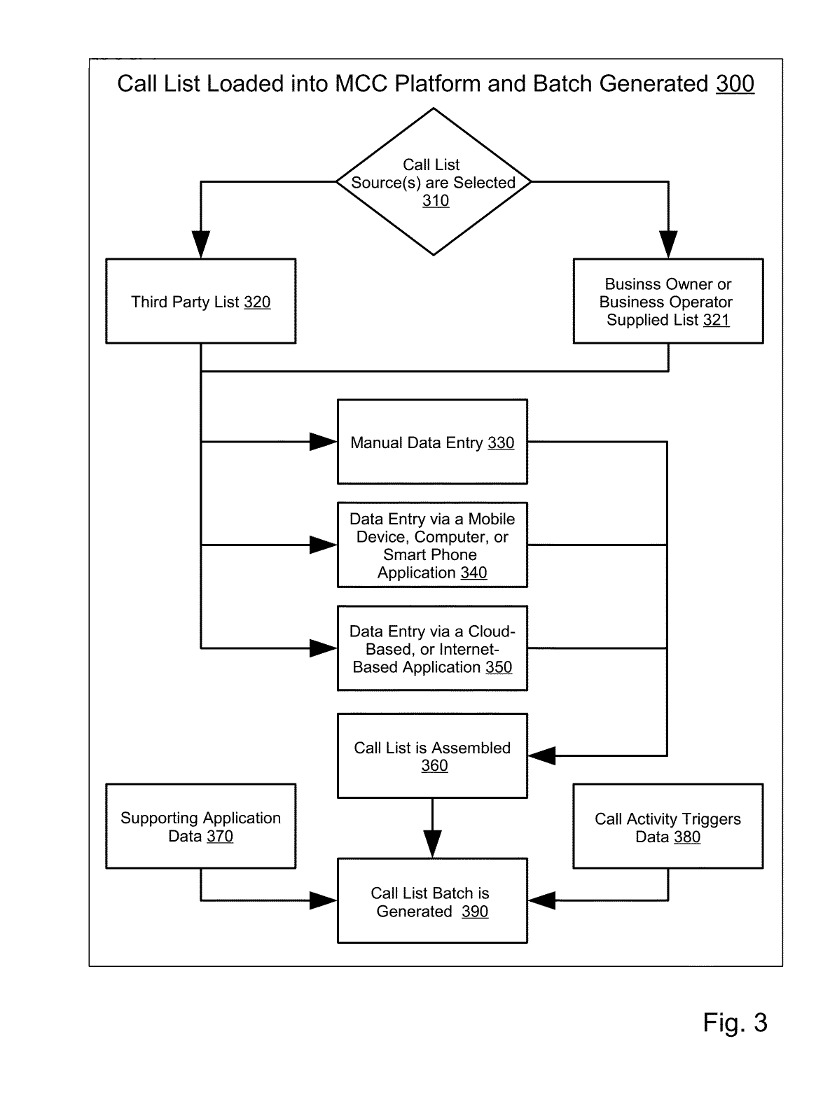

Next the Call List is Loaded and a Batch is Generated 300, which is further illustrated in FIG. 3.

The next step in preparing a Call List Batch is to Select a Method for Generating Audio Message 250. There are several options, which are detailed below.

In one option, an Audio Message is Uploaded to the MCC Platform 252. The message may be one self-contained audio recording, or a series of messages that when combined create the perception of a single message to the customer. The messages may be pre-recorded, or automatically generated by voice generation technologies. In addition, foreign language translation technologies may be used within the present invention. The scripts may be static in nature or dynamic based upon any number of inputs and variables including, but not limited to: customer name, service date, delivery date and time, current date and time, weather conditions, business inputs such as pricing and specials, etc. The voice message may be recorded professionally, or with other voice recording tools.

Alternatively, an audio message may be generated when a Call Agent Records Audio Message Directly onto the MCC Platform 253 when the Call Agent places a call to the present invention's Mobile Call Center Platform, or upon the Call Agent receiving a call from the present invention's Mobile Call Center Platform. The present invention's Mobile Call Center Platform can provide playback, delete, and other voice scripting editing capabilities.

Alternatively, the option exists within the present invention for Call Agent Records Audio Message onto Personal Device 251. In this alternate step, the Call Agent can record a message for upload onto the present invention's Mobile Call Center Platform, and subsequently Audio Message is Uploaded to the MCC Platform 254.

Recording voice scripts may be accomplished using a combination methods including, but not limited to: using an associated Mobile Call Center Platform application that can run on any number of supporting frameworks including, but not limited to: devices running Microsoft Windows, Apple iOS, Mac OSX, Android, Linux, or other operating systems and application support frameworks including browsers such as Google Chrome, Apple Safari and Microsoft Internet Explorer. Examples would include iPhone, iPad, PC, Mac and Android based applications; or

Alternatively (not shown), the present invention may provide for the use of third-party script recording and/or editing tools on any of the aforementioned devices, and then importing the recording into the present invention's Mobile Call Center Platform application, or directly uploading or transmitting the recording to the present invention's Mobile Call Center Platform from the third-party application by any number of data transport methods including, but not limited to: simple file transport, e.g. FTP/SFTP, HTTP/S, shared file and data storage mechanisms including cloud-based storage and/or using a MCC Platform web service/API interface; etc.

The Platform provides capabilities, such as, but not limited to, imaging, touch pad, touch screen, location, voice recognition, etc, as means for Business Owners, Business Operators, Customers, and Call agents to interact with the system.

FIG. 3 is an illustration of the high level processes used in the present invention that describe the Call List Loaded into MCC Platform and Batch Generated 300.

In this sub-process, first the Call List Source(s) are Selected 310. These sources include, but are not limited to: a list provided by a business owner or business operator, a third party list, or a hybrid list that includes both sources.

The list(s) may be entered into the present invention's Mobile Call Center Platform via a variety of methods, including, but not limited to at least one, or a plurality, of the following: Manual Data Entry 330, or Data Entry via a Mobile Device, Computer, or Smart Phone Application 340, Data Entry via a Cloud-Based, or Internet-Based Application 350, which may further be defined by batch file imports, application programming interface, user-interface, etc.

The Call List is Assembled 360 that includes potential customers for a particular batch job.

The Call List is merged with the Supporting Application Data 370, and Call Activity Triggers Data 380 such that a Call List Batch is Generated 390, and ready for execution.

The Platform provides capabilities, such as, but not limited to, imaging, touch pad, touch screen, location, voice recognition, etc, as means for Business Owners, Business Operators, Customers, and Call agents to interact with the system.

FIG. 4 is a flow chart of functional components used in the present invention.

Data Files (CSV, TEXT, XLS, XML) 400, this list of data files types is exemplary, and not all inclusive, are handled via a Batch File Import 410 engine into the MCC Platform API 450 engine. In addition, a Business Owner Database 420 or Third Party Database 430 may be operatively connected to the MCC Platform API 450 engine. In addition, a Public REST API 440 may be operatively connected to the MCC Platform API 450 engine.

The MCC Platform API 450 engine is connected to the present invention's Database 460, which is where the Call List Batch, which is comprised of the list of numbers to call plus the supporting application data plus the call activity triggers reside.

The Database 460 is connected to the Call Processing Workflows 470 engine, and the Call Processing Engine 480.

The Platform provides capabilities, such as, but not limited to, imaging, touch pad, touch screen, location, voice recognition, etc, as means for Business Owners, Business Operators, Customers, and Call agents to interact with the system.

The following list of attachments are incorporated for describing underlying technologies, and also features of objects of the present invention, this list of attached articles (attached in no particular order) are entitled as follows:

The present invention has been described in particular detail with respect to several possible embodiments. Those of skill in the art will appreciate that the invention may be practiced in other embodiments. First, the particular naming of the components and capitalization of terms is not mandatory or significant, and the mechanisms that implement the invention or its features may have different names, formats, or protocols. Also, the particular division of functionality between the various system components described herein is merely exemplary, and not mandatory; functions performed by a single system component may instead be performed by multiple components, and functions performed by multiple components may instead performed by a single component.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage devices. Certain aspects of the present invention include process steps and instructions. It should be noted that the process steps and instructions of the present invention could be embodied in software, firmware or hardware, and when embodied in software, could be downloaded to reside on and be operated from different Platforms.

Furthermore, the computers referred to in the specification may include a single processor, or may be architectures employing multiple processor designs, for increased computing capability.

The scope of this invention should be determined by the appended claims and their legal equivalents, rather than by the examples given.

What is claimed is:

1. A mobile call system, the system comprising:
a batch file import engine configured to receive one or more data files;
an external database for storing the one or more data files;
an application programming interface configured to receive and process the one or more data files from the batch file import engine and the external database;
an internal database configured to store one or more call lists for batch processing by the mobile call system; and
a call processing engine for executing the call lists.

2. The system of claim 1, wherein the one or more data files may be formatted in a format selected from the group consisting of CSV, TEXT, XLS, and XML.

3. The system of claim 1, further comprising a Public REST application programming interface.

4. The system of claim 1, further comprising a call processing workflow engine, said call processing workflow engine configured to generate call lists based on one or more user defined metrics.

5. The system of claim 1, wherein the mobile calling system is configured to receive information from a user via imaging, image recognition, touch pad, touch screen, computer keyboard, and voice recognition.

6. A method of generating a call list, the method comprising:
collecting basic data within a mobile call system that is related to one or more user defined metrics;
establishing a set of call list processing rules based on the collected data;
generating a call list of potential customers based on the one or more user defined metrics; and
selecting an audio message to be played to the potential customers on the call list.

7. The method of claim 6, wherein the basic data includes business name, physical address, mailing address, billing information, contact name, telephone numbers, source of call list, uploading a call list, length of campaign, type of campaign, time zone restrictions, training materials, time-of-day restrictions, day-of-week restrictions, holiday restrictions, reporting requirements, do not call indicator, IP address, or domain name.

8. The method of claim 6, wherein the established set of call list processing rules comprise establishing the potential customers availability during a day, during a week, and during a month.

9. The method of claim 6, wherein the established set of call list processing rules comrpise confirming the potential customers location and local time zone.

10. The method of claim 6, wherein the selected audio message is a self-contained audio recording that is uploaded to the mobile call system.

11. The method of claim 6, wherein the selected audio message is recorded directly to the mobile call system by the user.

12. The method of claim 6, further comprising selecting a source for the list of individuals to be included in the call list.

13. The method of claim 6, further comprising entering the call list in the mobile call system.

14. The method of claim 13, wherein the call list is uploaded to the mobile call system.

15. A method of processing a call list, the method comprising:
logging on to a mobile call system;
defining one or more metrics related to individuals that are potential customers;
generating a call list comprised of individuals who meet the one or more user defined metrics; and
instructing the mobile call system to begin calling individuals from the generated call list.

16. The method of claim 15, further comprising the step of determining that the call placed by the mobile call system was received by a potential customers.

17. The method of claim 16, wherein whether the call is received is determined by requesting the potential customers receiving the calls from the mobile call system to press a button on the phone, pressing said button will generate a dual-tone multi-frequency signal that may be recognized by the mobile calling system.

17. The method of claim 15, further comprising playing an audio recording for the potential customers.

18. The method of claim 15, further comprising forwarding the calls answered by the potential customers to calling agents.
